(19) United States
(12) Patent Application Publication
(10) Pub. No.: US 2005/0074242 A1
(43) Pub. Date: Apr. 7, 2005

(54) Apparatus and method for controlling multi-master devices with pseudo IR signals

(76) Inventors: Rong-Jung Lee, Tainan Hsien (TW); Shao-Pin Chiang, Miaoli Hsien (TW)

Correspondence Address: HARNESS, DICKEY & PIERCE, P.L.C., P.O. BOX 8910, RESTON, VA, 20195, US

(21) Appl. No.: 10/922,895

(22) Filed: Aug. 23, 2004

(30) Foreign Application Priority Data
Sep. 9, 2003 (TW) 092124871

(51) Int. Cl. H04N 5/44

(52) U.S. Cl. 398/106; 340/825.72; 398/111

(57) ABSTRACT

An apparatus and method for controlling multi-master devices with pseudo IR signals is used by setting one of the master devices as a master module and others as pseudo slave module, the master module receiving and decoding the IR signals, and then confirming the IR signals are used to control which device. If the signals decoded from the IR signal are used to control the master module, the apparatus uses the signal to control the master module. Otherwise, if the signals decoded from the IR signal are used to control the pseudo slave module, the apparatus generates a pseudo IR signal and sends the pseudo IR signal to pseudo slave module, to control the manipulation of the pseudo slave module.

### BACKGROUND OF THE INVENTION

1. Field of Invention

The present invention relates to an apparatus and method for controlling multi-master devices, in particular, to an apparatus and method for controlling multi-master devices with pseudo IR signals.

2. Related Art

The technology of the television has developed for about 100 years. From monochrome television to color TV and mono to stereo, every evolution process was a fruitful result of a breakthrough of the technology.

Because of many advantages and less fabrication costs of the Cathode Ray Tube (CRT), it has dominated the display and the television market for a long time without any decay. To answer to the variety of the information production, the need of a Flat Panel Display (FPD) is increasing urgently. The trend of the information production of the global marketing is to become smaller and use less electricity, so the CRT is replaced by the FPD stage by stage.

The technology development of the Liquid Crystal Display Television (LCD TV) has matured comparatively, and the LCD TV uses the following advantages: using less electricity, generating no pollution, having less volume, having more environmental protection and no radiation . . . etc. So, the LCD TV has become very popular in the television industry and invaded the home appliance market.

The Digital Video Disc (DVD) player is a device for playing the Digital Video Disc. The Digital Video Disc stores image data by MPEG 2 compressing technology, so the Digital Video Disc has less volume and larger storage capacity to replace the 12 inch laser disk. Because the manufacturing technology has matured and the prices are acceptable, the market of the DVD player grows gradually.

Referring to FIG. 1 shows the conventional control of the LCD TV 10 and the DVD player 20. Because the remote control 11, 12 of the LCD TV 10 and the DVD player 20 were set as master modes in the manufacturing process, the manipulations of the LCD TV 10 and the DVD player 20 need two different remote controls 11, 12 to control two different interfaces.

The IR signals emitted by the remote control 11, 12 are received by an IR signal receiving unit 12, 22 respectively. The decoding module 14, 24 decodes the IR signals and transfers the IR signals into I²C interface to control the LCD TV system 13 and the DVD player system 23 respectively.

Therefore, customers have to buy these devices and connect the output port of the DVD player 20 with the input port of the LCD TV 10 themselves, to watch a movie with DVD player 20.

### SUMMARY OF THE INVENTION

But if the users can not understand the connection of the transmission lines (about the transmission lines connected with the input ports or output ports) in the manual, they still can not see a movie on the LCD TV with the DVD player after working hard with the transmission lines connected between the LCD TV and the DVD player.

In view of the foregoing problems, it is an objective of the invention to provide an apparatus and method for controlling multi-master devices with pseudo IR signals. The goal is to set one of the LCD TV and the DVD players as a master module, and the other as a pseudo slave module. The master module receives the IR signals, and then the decoding unit of the master module decodes the IR signal and transfers the IR signal into a control signal. Then the control unit analyzes the control signal to confirm that the IR signal is used to control the manipulation of the master module or the pseudo slave module.

If the control signal is used to control the function of the master module, the apparatus sends the control signal to the control unit of the master module, to control the manipulation of the master module.

Otherwise, if the control signal is used to control the pseudo slave module, the apparatus generates a pseudo IR signal according to the original control signal and sends the pseudo IR signal to the pseudo slave module, to control the manipulation of the pseudo slave module.

In the following text, we set the LCD TV as the master module and the DVD player as the pseudo slave module to explain the disclosed apparatus and method.

Due to setting the LCD TV as the master module, the IR signal receiving unit of the LCD TV receives the IR signal emitted by the remote control. Then, the decoding unit decodes the IR signal and analyzes the IR signal. This is used to control the LCD TV or the DVD player.

If the IR signal is used to control the function of the LCD TV such as quality adjustment, volume, bilingual setting . . . etc., the apparatus transfers the IR signal into a control signal and sends the control signal to the control unit of the LCD TV, to control the image output of the LCD TV.

On the contrary, if the IR signal is used to control the function of the DVD player such as play, pause, stop . . . etc., the control unit of the master module generates a pseudo IR signal and sends the pseudo IR signal to the DVD player. Then, the IR signal receiving unit of the DVD player receives the pseudo IR signal, to manipulate different functions of the DVD player.

Besides using one remote control to control the manipulation of the multi-master devices described above, one can also set an IR signal receiving unit, a decoding unit and an identification unit additionally. The IR signal receiving unit receives the IR signal, and then the decoding unit decodes the IR signal. Finally, the identification unit confirms that the control signal is used to control the master module or the pseudo slave module.

The identification unit generates a pseudo IR signal according to the original IR signal, and sends the pseudo IR signal to the LCD TV or the DVD player selectively to control their manipulation.

The customers can use LCD TV or DVD player functions in the apparatus for controlling multi-master devices with pseudo IR signals simultaneously. This also helps to save the space occupied by the LCD TV or the DVD player when they are separated from each other, and people won't be confused by the transmission lines connected between the LCD TV and the DVD player. The apparatus would really increase the convenience of manipulation.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a diagram of conventional control of the LCD TV and the DVD player;

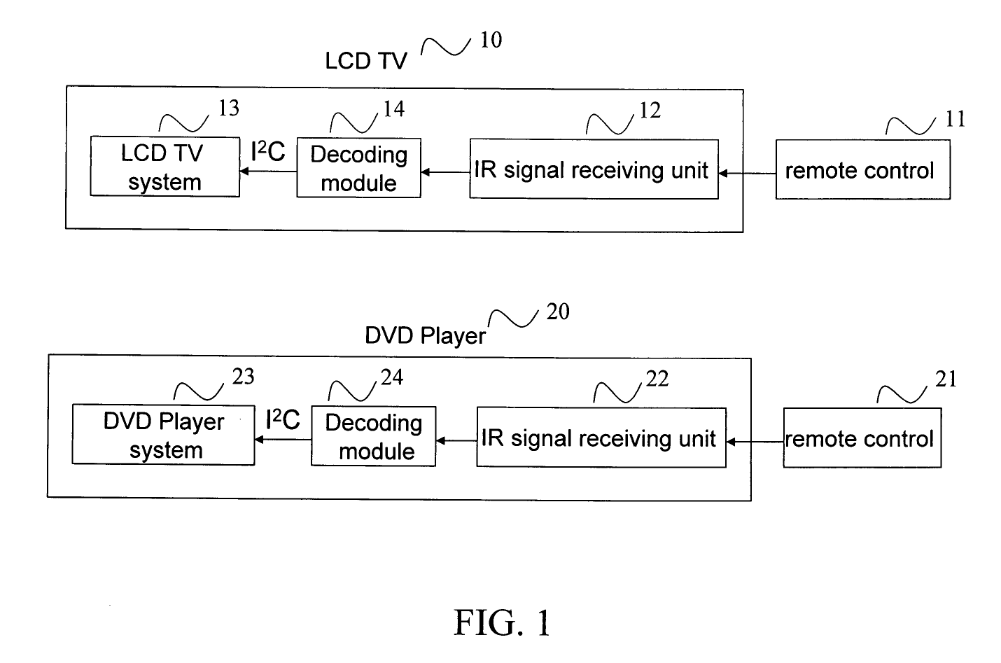

FIG. 2 is a system structure of the first embodiment of the disclosed apparatus for controlling multi-master devices with pseudo IR signals;

FIG. 3 is a flowchart of the first embodiment of the disclosed method for controlling multi-master devices with pseudo IR signals;

FIG. 4 is a system structure of the second embodiment of the disclosed apparatus for controlling multi-master devices with pseudo IR signals; and

FIG. 5 is a flowchart of the second embodiment of the disclosed method for controlling multi-master devices with pseudo IR signals.

### DETAILED DESCRIPTION OF THE INVENTION

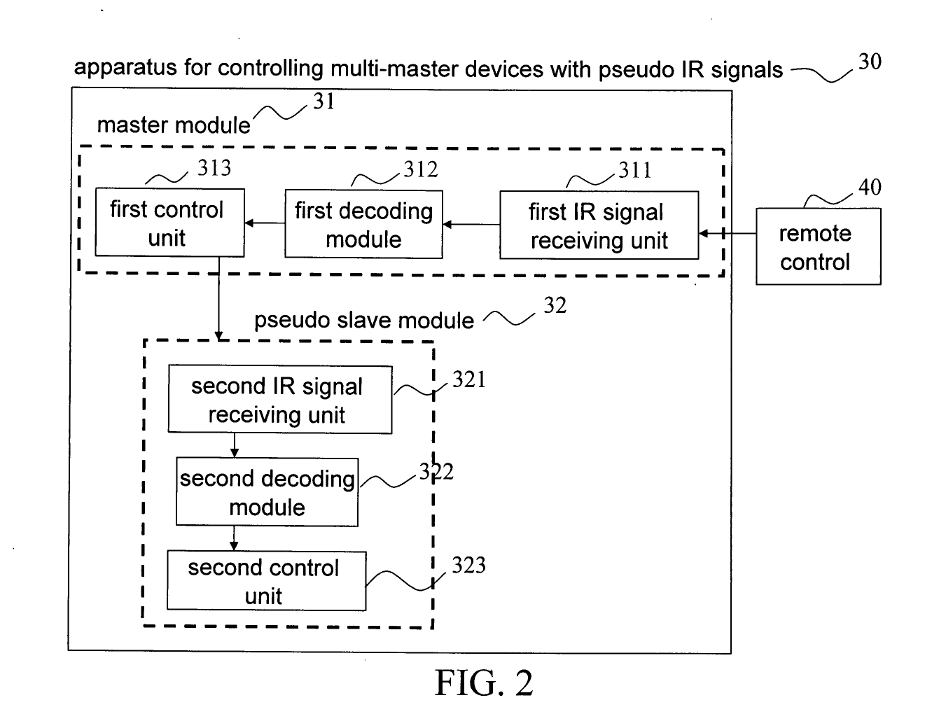

As shown in FIG. 2, this is a system structure of the first embodiment of the disclosed apparatus for controlling multi-master devices with pseudo IR signals 30. (In the first embodiment, we use the combination of LCD TV or the DVD player as an example to explain. Of course, the disclosed apparatus and method for controlling multi-master devices with pseudo IR signals can also apply to the combination of more than two master devices.)

By setting the LCD TV as a master module 31 and the DVD player as a pseudo slave module 32, people can use a single remote control 40 to control the manipulation of the master module 31 or the pseudo slave module 32.

The master module 31 includes a first IR signal receiving unit 311, a first decoding module 312 and a first control unit 313. The pseudo slave module 32 includes a second IR signal receiving unit 321, a second decoding module 322 and a second control unit 323.

The first IR signal receiving unit 311 of the master module 31 receives the IR signal emitted from the remote control 40. Then, the first IR signal receiving unit 311 sends the IR signal to the first decoding module 312 to decode the IR signal and transfer the IR signal into a control signal.

Next, the first decoding module 312 sends the control signal to the first control unit 313, and then the first control unit 313 analyzes the control signal to confirm that the control signal is used to control the master module 31 or the pseudo slave module 32.

If the control signal is used to control the master module 31, the apparatus sends the control signal to the first control unit 313 of the master module 31, to control the manipulation of the master module 31.

Otherwise, if the control signal is used to control the manipulation or setting of the pseudo slave module 32, the first control unit 313 generates a pseudo IR signal according to the original control signal and sends the pseudo IR signal to the second IR signal receiving unit 321 of the pseudo slave module 32.

Afterwards, the second IR signal receiving unit 321 sends the pseudo IR signal to the second decoding module 322 to decode the pseudo IR signal and transfers the pseudo IR signal into a control signal. And then, the second decoding module 322 sends the control signal to the second control unit 323 to control the functions of the pseudo slave module 32.

Like this, people can use a single remote control 40 to control the master module 31 (LCD TV) and the pseudo slave module 32 (DVD player) of the apparatus for controlling multi-master devices with pseudo IR signals 30. They do not have to control the LCD TV 10 and the DVD player 20 with different remote controls 11, 21, so this apparatus helps to improve the convenience of the manipulation.

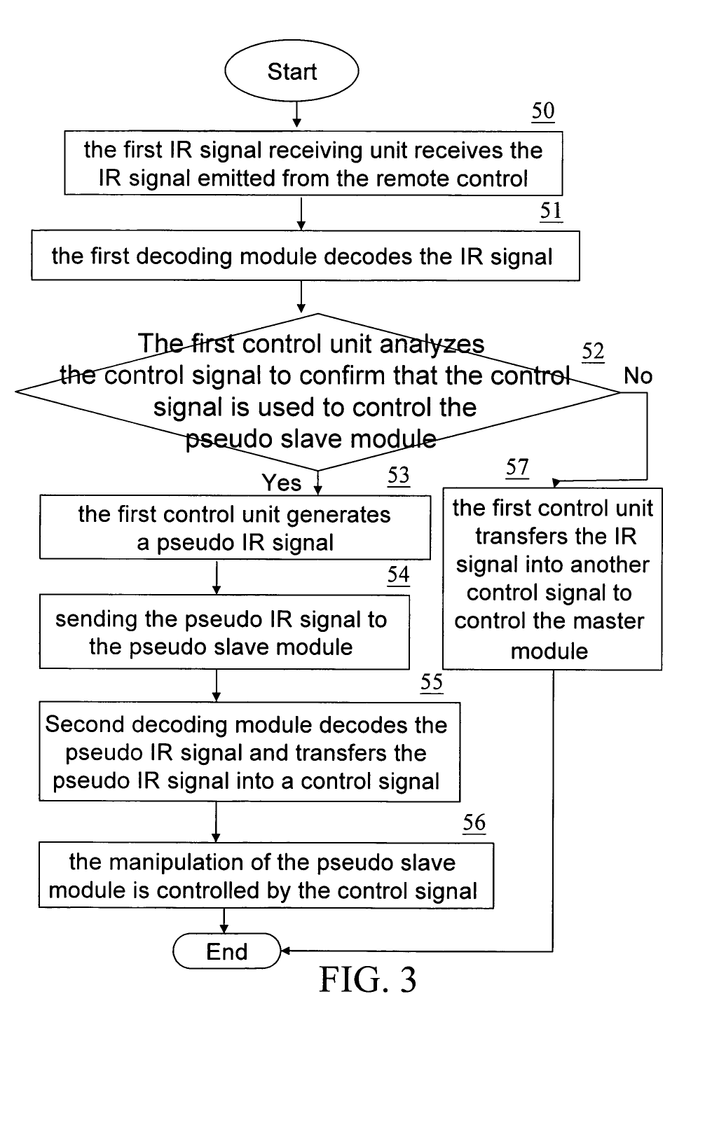

In FIG. 3, the flowchart is shown of the first embodiment of the disclosed method for controlling multi-master devices with a pseudo IR signal. By using the first control unit 313 of the master module 31 to analyze the control signal, this confirms that the control signal is used to control the master module 31 or the pseudo slave module 32. Then, the first control unit 313 sends the control signal to the master module 31 or the pseudo slave module 32 selectively according to the control signal to control the functions of the master module 31 or the pseudo slave module 32. Please refer to FIG. 2 whenever the operation architecture of the system is mentioned.

First, the first IR signal receiving unit receives the IR signal emitted from the remote control (step 50). Then, the first decoding module decodes the IR signal (step 51) and transfers the IR signal into a control signal. The first control unit analyzes the control signal to confirm that the control signal is used to control the pseudo slave module (step 52).

Afterwards, the first control unit generates a pseudo IR signal (step 53) and sends the pseudo IR signal to the pseudo slave module (step 54). The second IR signal receiving unit 321 receives the pseudo IR signal.

The second decoding module decodes the pseudo IR signal and transfers the pseudo IR signal into a control signal (step 55). Then, the manipulation of the pseudo slave module is controlled by the control signal (step 56).

If the first control unit analyzes the control signal, to confirm that the control signal is used to control the master module in (step 52), the first control unit transfers the IR signal into another control signal to control the master module (step 57).

In the first embodiment of the apparatus for controlling multi-master devices with the pseudo IR signal described above, we set the LCD TV as the master module 31 and the DVD player as the pseudo slave module 32. The manipulation of the apparatus can be controlled by a single remote control 40.

But we can still reverse the relationship by setting the DVD player as the master module 31 and the LCD TV as the pseudo slave module 32. The IR signal receiving unit of the DVD player receives the IR signal and transfers the IR signal into the pseudo IR signal selectively, to control the display of the LCD TV. Otherwise, we can use the first embodiment described to combine many master devices as one apparatus for controlling multi-master devices with pseudo IR signals and manipulating the apparatus by single remote control. Because the principle is similar to the first embodiment, we won't describe the details here again.

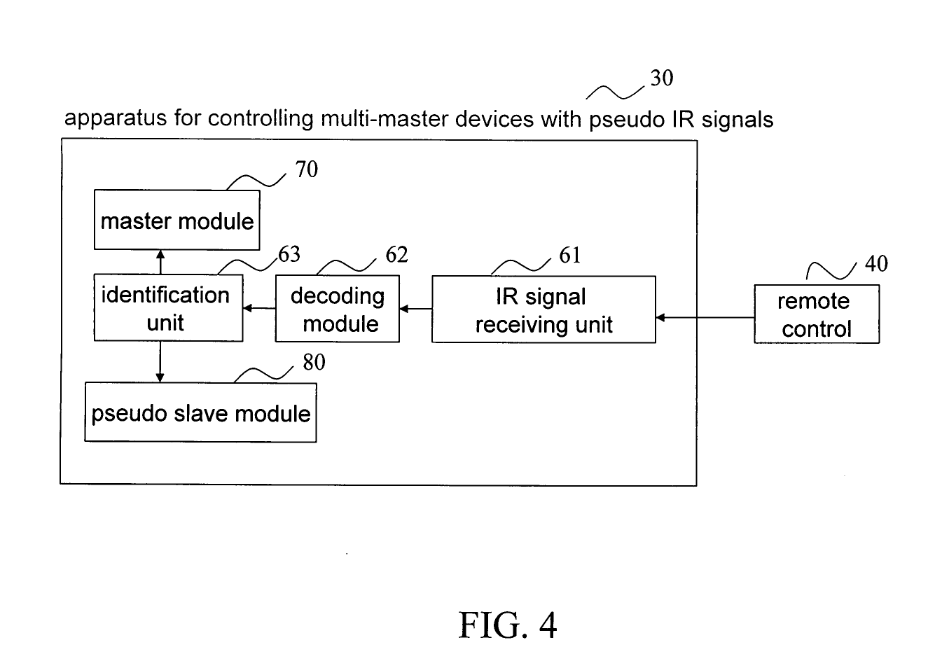

As shown in FIG. 4, this is a system structure of the second embodiment of the disclosed apparatus for controlling multi-master devices with pseudo IR signals 30. The apparatus for controlling multi-master devices with pseudo IR signals 30 includes an IR signal receiving unit 61, a decoding module 62, an identification unit 63, a master module 70 and a pseudo slave module 80.

The IR signal receiving unit 61 receives the IR signal emitted by the remote control 40. Then, the decoding module 62 decodes the IR signal and transfers the IR signal into a control signal. Finally, the identification unit 63 confirms that the control signal is used to control the master module 70 or the pseudo slave module 80. Then, the identification unit 63 generates a pseudo IR signal according to the control signal and sends the control signal to the master module 70 or the pseudo slave module 80, to control the manipulation of the master module 70 and the pseudo slave module 80.

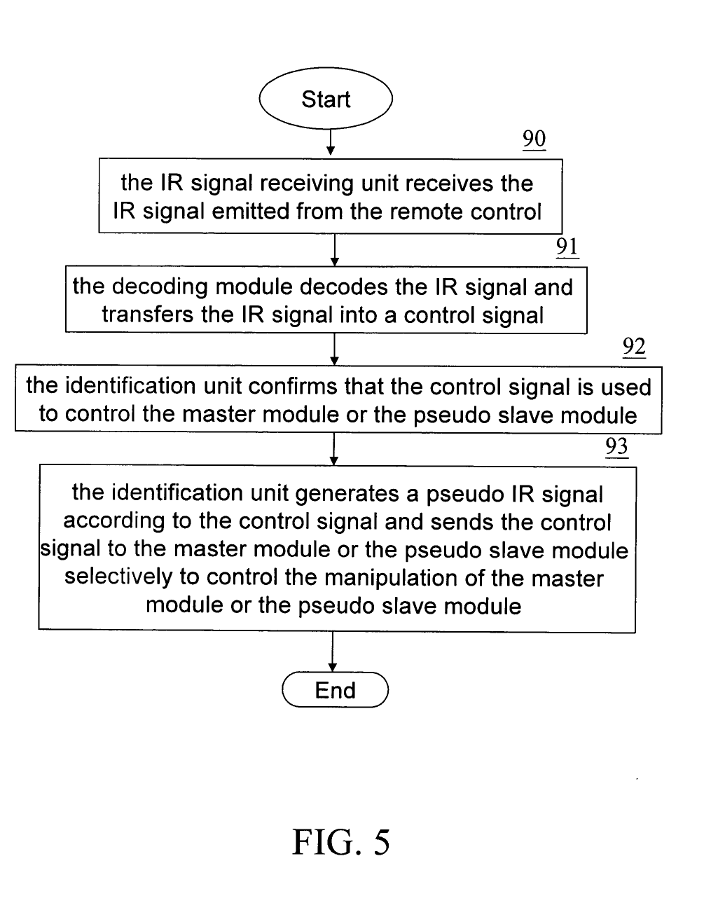

FIG. 5 shows the flowchart of the first embodiment of the disclosed method for controlling multi-master devices with pseudo IR signals. Please refer to FIG. 4 whenever the operation architecture of the system is mentioned.

First, the IR signal receiving unit receives the IR signal emitted from the remote control (step 90). Then, the decoding module decodes the IR signal and transfers the IR signal into a control signal (step 91).

After that, the identification unit confirms that the control signal is used to control the master module or the pseudo slave module (step 92). Finally, the identification unit generates a pseudo IR signal according to the control signal and sends the control signal to the master module or the pseudo slave module selectively, to control the manipulation of the master module or the pseudo slave module (step 93).

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An apparatus for controlling multi-master devices with pseudo IR signals, the apparatus being controlled by an IR signal emitted from a remote control, comprises of:
a master module, comprising of:
a first IR signal receiving unit, for receiving the IR signal;
a first decoding module, for decoding the IR signal and transferring the IR signal into a control signal; and
a first controlling unit, for analyzing the control signal to confirm whether the control signal is directed to control the master module, if not, generating and sending a pseudo IR signal; and
a pseudo slave module, comprising of:
a second IR signal receiving unit, for receiving the pseudo IR signal;
a second decoding module, for decoding the IR signal and transferring the IR signal into an another control signal; and
a second control unit, for analyzing the another control signal to control the pseudo slave module.

2. The apparatus for controlling multi-master devices with pseudo IR signals of claim 1, wherein the master module is a liquid crystal display television.

3. The apparatus for controlling multi-master devices with pseudo IR signals of claim 1, wherein the master module is a digital video disc (DVD) player.

4. The apparatus for controlling multi-master devices with pseudo IR signals of claim 1, wherein the pseudo slave module is a liquid crystal display television.

5. The apparatus for controlling multi-master devices with pseudo IR signals of claim 1, wherein the pseudo slave module is a digital video disc (DVD) player.

6. A method for controlling multi-master devices with pseudo IR signals, controlling a master module and a pseudo slave module by a control unit, which comprises the step of:
(a) receiving an IR signal;
(b) decoding the IR signal;
(c) confirming that the IR signal is used to control the pseudo slave module;
(d) generating a pseudo IR signal;
(e) sending the pseudo IR signal to the pseudo slave module;
(f) decoding the pseudo IR signal;
(g) transferring the pseudo IR signal into a control signal; and
(h) controlling the pseudo slave module by the control signal.

7. The method for controlling multi-master devices with pseudo IR signals of claim 6, wherein in the (c) step, if confirming that the IR signal is not used to control the pseudo slave module, transferring the IR signal into an another control signal to control the master module.

8. An apparatus for controlling multi-master devices with pseudo IR signals, the apparatus being controlled by an IR signal emitted from a remote control, comprises of:
a master module;
a pseudo slave module;
an IR signal receiving unit, for receiving the IR signal;
a decoding module, for decoding the IR signal and transferring the IR signal into a control signal; and
an identification unit, for confirming that the control signal is used to control the master module or the pseudo slave module to sending the control signal to the master module or generating a pseudo IR signal to the pseudo slave module selectively to control the master module or the pseudo slave module.

9. The apparatus for controlling multi-master devices with pseudo IR signals of claim 8, wherein the master module is a liquid crystal display television.

10. The apparatus for controlling multi-master devices with pseudo IR signals of claim 8, wherein the master module is a digital video disc (DVD) player.

11. The apparatus for controlling multi-master devices with pseudo IR signals of claim 8, wherein the pseudo slave module is a liquid crystal display television.

12. The apparatus for controlling multi-master devices with pseudo IR signals of claim 8, wherein the pseudo slave module is a digital video disc (DVD) player.

13. A method for controlling multi-master devices with pseudo IR signals, controlling a master module and a pseudo slave module by an identification unit, which comprises the step of:
(a) receiving an IR signal;
(b) decoding the IR signal;
(c) transferring the IR signal into a control signal;
(d) confirming that the IR signal is used to control the master module or the pseudo slave module; and
(d) sending the control signal to the master module or generating a pseudo IR signal to the pseudo slave module selectively to control the master module or the pseudo slave module.
